(19) United States
(12) Patent Application Publication
(10) Pub. No.: US 2019/0259088 A1
(43) Pub. Date: Aug. 22, 2019

(54) METHOD AND SYSTEM FOR DETERMINING HYDROGEN SUPPLY LOCATION, COST, AND INFRASTRUCTURE

(71) Applicant: Hyster-Yale Group, Inc., Fairview, OR (US)

(72) Inventor: Kyle COOPER, Greenville, NC (US)

(73) Assignee: Hyster-Yale Group, Inc., Fairview, OR (US)

(21) Appl. No.: 16/279,347

(22) Filed: Feb. 19, 2019

Related U.S. Application Data
(60) Provisional application No. 62/632,112, filed on Feb. 19, 2018.

(51) Int. Cl. G06Q 30/06

(52) U.S. Cl. CPC G06Q 30/0639; H01M 8/04201; G06Q 30/0629

(57) ABSTRACT

A computer-implemented method for automatically determining a hydrogen supply source comprises executing on one or more processors, an online tool that enables users to find potential hydrogen options and a rough order magnitude (ROM) pricing. Based on a user specified user location and a desired hydrogen consumption amount, a data repository of supplier solutions and pricing is filtered to find a supplier solution for the user, wherein the online tool also determines which technologies, including onsite reformer or electrolysis, or delivery as gas or liquid, should be employed by the user, and an estimated cost for supporting infrastructure and equipment. The returned results are then displayed to the user.

### RELATED APPLICATIONS

The present application claims priority to U.S. Provisional Patent Application No. 62/632,112, filed Feb. 19, 2018, entitled “METHOD AND SYSTEM FOR DETERMINING HYDROGEN SUPPLY LOCATION, COST, AND INFRASTRUCTURE”, the entire disclosure of which is hereby incorporated by reference.

### BACKGROUND

A fuel cell is an energy conversion device used to capture and use the power of hydrogen. It produces electricity from hydrogen and oxygen, with water vapor and heat as the only byproducts. Numerous organizations are integrating fuel cell technology into industrial vehicle fleets (in addition to recreational vehicles and automobiles) to benefit from lower operational costs, reduced emissions and improved reliability. Examples of industrial vehicles incorporating fuel cells include trucks and forklifts, which are also referred to as “lift” trucks. Now, major lift truck brands are bringing fuel cell technology in-house, with ultimate plans to offer hydrogen lift truck solutions with factory warranty coverage.

A steady, cost-effective supply of hydrogen is critical to the success of any hydrogen powered operation, and is an important consideration in the implementation of hydrogen fuel cell-powered lift trucks. In today's market, hydrogen can either be delivered or generated on-site. Options for delivery range from gaseous hydrogen shipped via tube trailers for lower-volume usage or liquid state hydrogen for higher-volume applications. Operations contemplating hydrogen can work with hydrogen (H2) suppliers to select a best-fit hydrogen fuel supply option, each with variable infrastructure, permitting and installation requirements, which can differ greatly based on fleet size, method of hydrogen delivery and anticipated demand.

However, with respect to hydrogen power forklifts, for example, it can take hundreds of man hours to select a hydrogen (H2) supplier/provider, and even then pricing is in the millions, making the ROI or justification to pursue H2 power almost worthless. Due to market conditions, fuel cells suppliers typically have an exclusive deal with a single large gas supplier, such as Praxair, which drives H2 prices higher due to lack of competition.

Accordingly, it would be desirable to provide an improved method and system for determining one or more of hydrogen supply location, cost, and infrastructure.

### BRIEF DESCRIPTION OF SEVERAL VIEWS OF THE DRAWINGS

FIG. 1 is a block diagram illustrating an exemplary system for automatically determining hydrogen supply sources according to one embodiment of the disclosure.

FIG. 2 is a flow diagram illustrating one embodiment of a process for automatically determining hydrogen supply source.

FIGS. 3A-3E are diagrams illustrating example user interfaces (UI) displayed by the hydrogen supply determination engine.

FIG. 4 is a diagram illustrating the process for automatically determining hydrogen supply sources in further detail.

FIG. 5 is a block diagram illustrating a process of calculating H2 pricing in further detail according to one embodiment.

### DETAILED DESCRIPTION

The exemplary embodiment relates to an automated tool for determining hydrogen supply location, cost, and infrastructure. The following description is presented to enable one of ordinary skill in the art to make and use the invention and is provided in the context of a patent application and its requirements. Various modifications to the exemplary embodiments and the generic principles and features described herein will be readily apparent. The exemplary embodiments are mainly described in terms of particular methods and systems provided in particular implementations. However, the methods and systems will operate effectively in other implementations. Phrases such as “exemplary embodiment”, “one embodiment” and “another embodiment” may refer to the same or different embodiments. The embodiments will be described with respect to systems and/or devices having certain components. However, the systems and/or devices may include more or less components than those shown, and variations in the arrangement and type of the components may be made without departing from the scope of the invention. The exemplary embodiments will also be described in the context of particular methods having certain steps. However, the method and system operate effectively for other methods having different and/or additional steps and steps in different orders that are not inconsistent with the exemplary embodiments. Thus, the present invention is not intended to be limited to the embodiments shown, but is to be accorded the widest scope consistent with the principles and features described herein.

Embodiments described herein provide methods and systems for automatically determining one or more of hydrogen supply location, cost and infrastructure. The example embodiments may be implemented through an online tool referred to as a hydrogen (H2) supply determination engine that enables user/dealers to find potential H2 options and a rough order magnitude (ROM) pricing. Based on user specified user location and a desired hydrogen consumption amount (e.g., kilograms per day), the H2 supply determination engine filters through a data repository of supplier solutions and pricing to find one or more supplier solutions for the user. The H2 supply determination engine includes algorithms to not only find H2 suppliers, but to also determine which technologies, including onsite reformer or electrolysis, or delivery as gas or liquid, should be employed by the user, and an estimated cost for supporting infrastructure/equipment, and provides results to the user.

With the H2 supply determination engine of the present embodiments, suppliers will now compete to have their offerings loaded onto the tool (pricing and locations added to the database) and will lower consumer pricing in order to be listed as an H2 supplier more frequently. The H2 supply determination engine drives competitive pricing and enables small suppliers to compete with large suppliers who control the market. Such a tool enables a more accessible network and infrastructure of H2 availability. According to the present embodiments, H2 cost will be lowered, making H2 a more economical and feasible option for many whom previously could not have afforded the equipment or recurring costs, thereby increasing sales of fuel cells for vehicles.

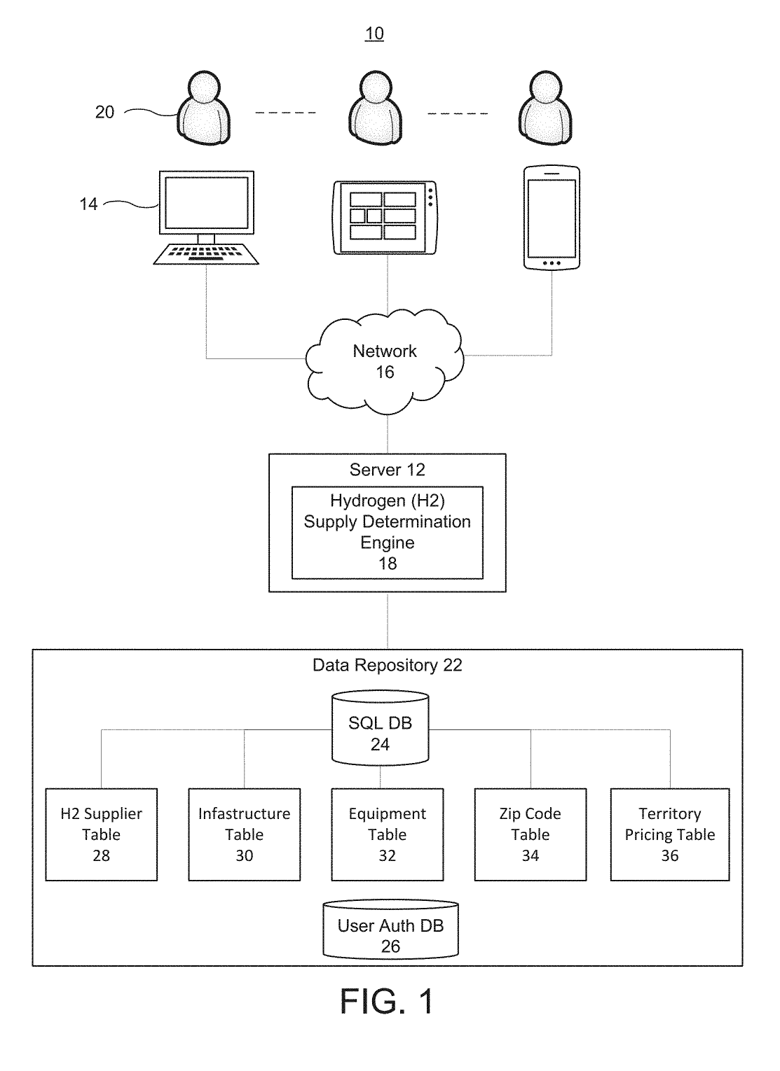

FIG. 1 is a block diagram illustrating an exemplary system for automatically determining hydrogen supply sources according one embodiment of the disclosure. In one embodiment, the system 10 is implemented as a client-server model in which one or more servers 12 is in communication with a plurality of client devices (or clients) 14 over a network 16 (e.g., the Internet). The server 12 hosts or executes a hydrogen supply determination engine 18 using one or more processors. The clients 14 comprise stationary and mobile computer systems operated by users 20. In one embodiment, the clients 14 initiate communication sessions with server 12, which in turn, awaits incoming requests. The clients 14 receive user input through a user interface, send requests to the server 12 for services from the hydrogen supply determination engine 18, and display results back to the users 20. As used herein, the term “users” may comprises H2 dealers and/or owners/operators of fuel cell equipped vehicles looking for H2 suppliers.

The server 12 is also in communication with a data repository 22 that may store user and supplier information in the form of one or more databases, which may include a structured query language (SQL) database 24. Other types of structured or unstructured databases may also be used. The data repository 22 may also include a user authorization database 26. Although many variations of database schemas may be implemented, according one specific embodiment, the database 24 may include an H2 supplier table 28, an infrastructure table 30, an equipment table 32, a ZIP Code table 34, and a territory pricing table 36.

In one embodiment, the H2 supplier table 28 stores information pertaining to each H2 supplier, including, but not limited to, location information, contact information, maximum amount of hydrogen stored and dispensed, dispensary locations, maximum delivery range for each location, and hydrogen costs per kilogram, and cost per delivery mile. The infrastructure table 30 stores information pertaining to infrastructure information requirements for each H2 supplier.

The equipment table 32 stores information pertaining to equipment packages offered by the supplier. For example, a supplier may offer a 100 kilogram package that might be a liquid infrastructure or a delivered infrastructure. It might also be electrolysis or reformer, in which case there is no actual H2 delivery, only equipment is delivered that generates hydrogen onsite at the user's facility. Such equipment packages are stored in the equipment table 32. The ZIP code table 34 stores ZIP code across a geographic region, such as Canada and the United States. The territory pricing table 36 stores pricing information such as H2 kilogram prices per state. In one embodiment, the tables in the SQL database 24 are indexed by a supplier or organization identifier (ID).

The user authentication database 26 maintains access control to the hydrogen supply determination engine 18 and confirms that a user who is attempting to log in is authorized to do so. In one embodiment, because the hydrogen supply determination engine 18 provides access to sensitive pricing information via the SQL database 24, the web version has to be accessed through a dealer portal, which requires dealers to first log in through a strict login requirement. Once the dealer login is validated by the user authentication database 26, the dealer invokes the hydrogen supply determination engine app. A token is passed and if the token is authenticated, the dealer is granted access, and if not and the dealer is denied. With respect to the mobile version of the app, the users are constantly logged in.

The data repository 22 may be hosted on the same server 12 as the hydrogen supply determination engine 18 or hosted on a different computer that is on the same or different network as server 12.

In one embodiment, the hydrogen supply determination engine 18 is implemented as a software component. In another embodiment, the hydrogen supply determination engine 18 could be implemented as a combination of hardware and software. Although a server 12 is shown hosting the hydrogen supply determination engine 18, the hydrogen supply determination engine 18 and the SQL database 24 may be run on any type of one more computers that have memory and processor.

Both the server 12 and the client devices 14 may include hardware components of typical computing devices (not shown), including a processor, input devices (e.g., keyboard, pointing device, microphone for voice commands, buttons, touchscreen, etc.), and output devices (e.g., a display device, speakers, and the like). Examples types of client devices 14 may include PCs, workstation, mobile phones, notebooks, laptops, tablets, watches and electronic voice enabled assistants (AI). The server 12 and client devices 14 may include computer-readable media, e.g., memory and storage devices (e.g., flash memory, hard drive, optical disk drive, magnetic disk drive, and the like) containing computer instructions that implement the functionality disclosed when executed by the processor. The server 12 and the client devices 14 include wired or wireless network communication interfaces for communication.

Although the server 12 is shown as a single computer, it should be understood that the functions of server 12 may be distributed over more than one server, and the functionality of software components may be implemented using a different number of software components. For example, the hydrogen supply determination engine 18 may be implemented as more than one component. In an alternative embodiment (not shown), the server 12, the hydrogen supply determination engine 18, and the data repository 22 may be implemented as a virtual entity whose functions are distributed over multiple computers.

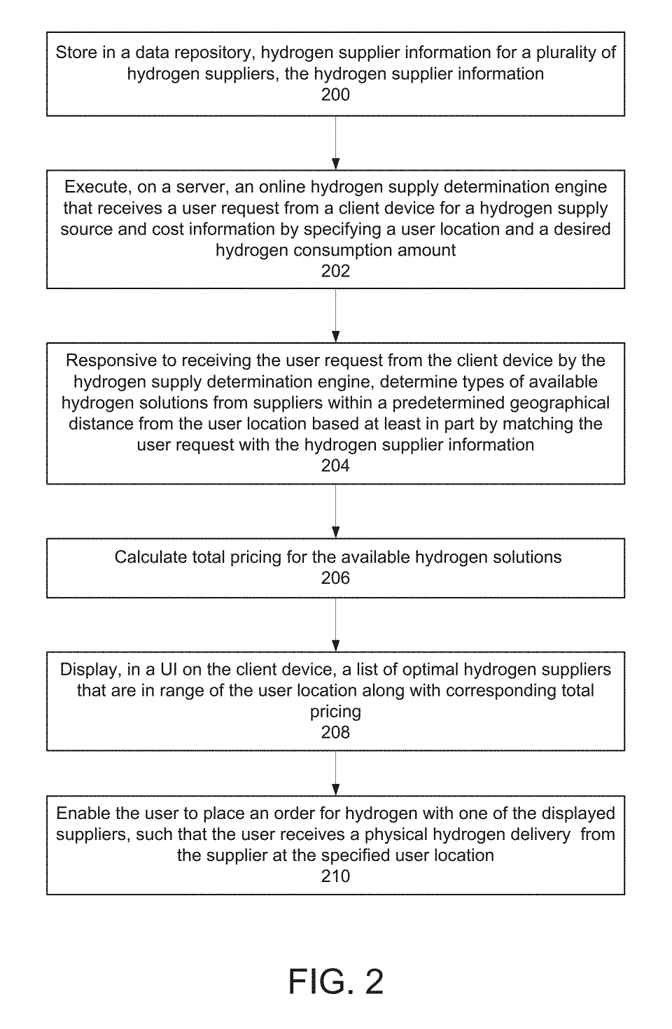

FIG. 2 is a flow diagram illustrating one embodiment of a process for automatically determining hydrogen supply source. The method may begin by storing in the data repository, hydrogen supplier information for a plurality of hydrogen suppliers (block 200). In one embodiment, the hydrogen supplier information may include contact data, delivery fees, infrastructure requirements, equipment and technology types, hydrogen output per day, and hydrogen pricing. It should be appreciated that a large part of the effort of enabling the system 10 is setting up the hydrogen supplier network and populating the SQL database 24 by partnering with the different industrial gas companies to forge agreements and agreeing to specified standards.

After the data repository is populated with sufficient amount of hydrogen supplier information, the hydrogen supply determination engine 18 is executed by the server 12 and receives as input a user request from a client device 20 for a hydrogen supply source and cost information by specifying a user location and a desired hydrogen consumption amount (block 202).

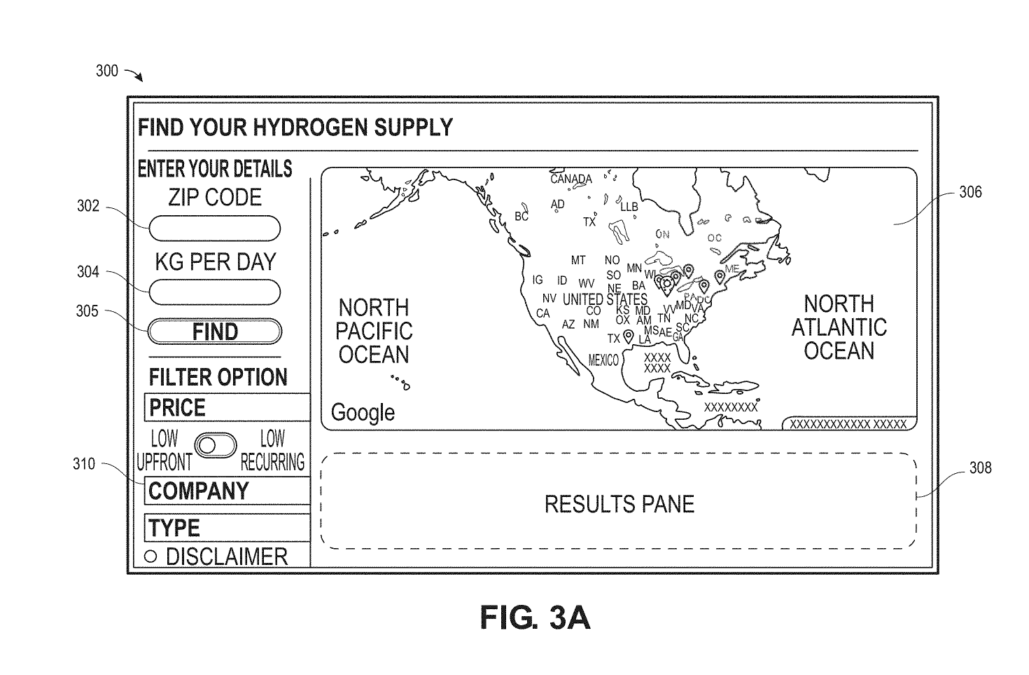

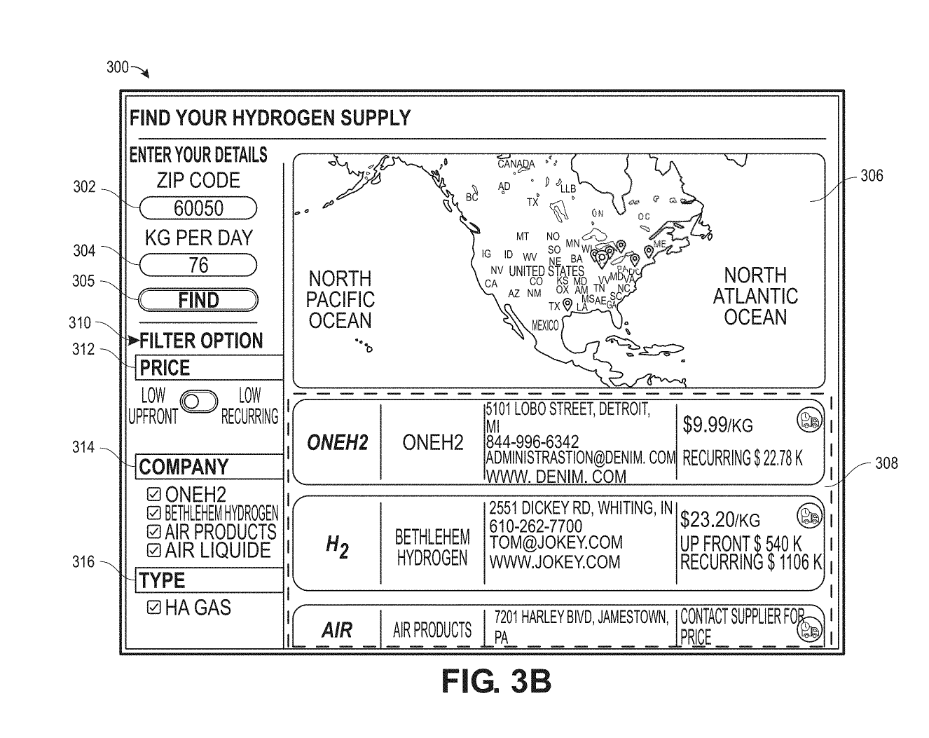

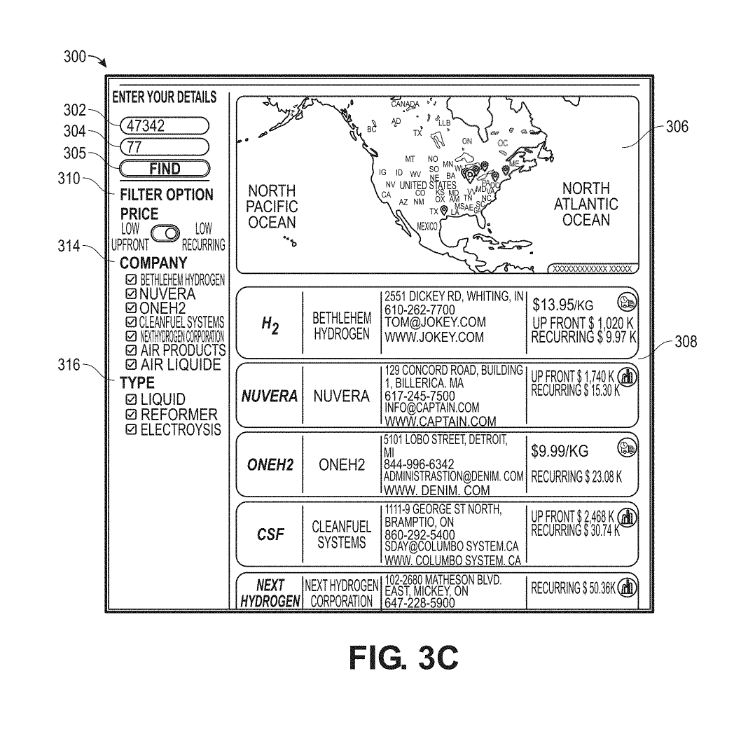

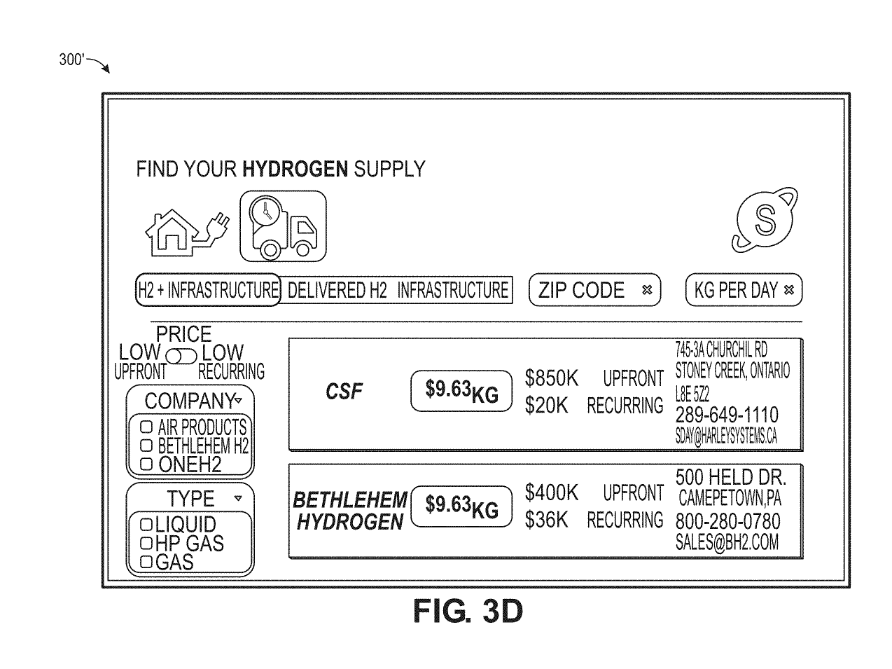

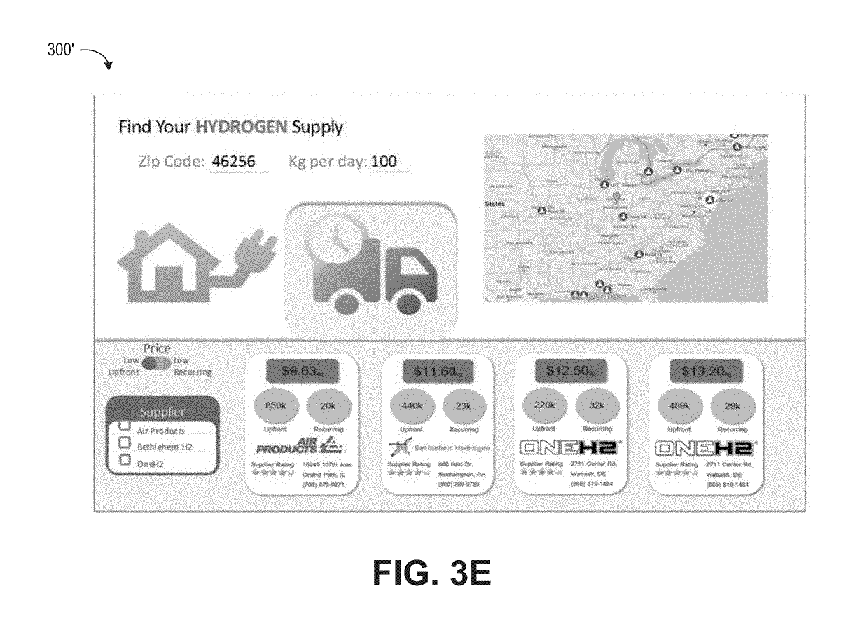

FIGS. 3A-3E are diagrams illustrating example user interfaces (UI) displayed by the hydrogen supply determination engine 18 that may be displayed on mobile and web-based versions. Referring to FIG. 3A, according to one embodiment the UI 300 is designed to be as simple to use for the user as possible. In this embodiment, the main window/page/screen 300 may display at least a location entry text box 302, an H2 consumption amount entry text box 304, a corresponding search/find button 305, and a results pane 308 (initially blank). Optionally displayed is a map pane 306 showing a map of the user's general current location (e.g., state/country) and locations of any suppliers displayed in the results pane 308, and a filter options pane 310 with options for filtering the results.

In one embodiment, the user location may be specified by entering a ZIP Code and the consumption amount may be represented as a numerical value in kilograms per day (KG per day). Alternatively, the user location may be specified by entering an address from which the ZIP Code can be determined. The user initiates a search request by populating the location entry text box 302 and the H2 consumption amount entry text box 304, and clicking the search/find button 305. The component of the hydrogen supply determination engine 18 executing on the client device 14 then forwards the user request to the server 12.

Referring again to FIG. 2, responsive to the hydrogen supply determination engine 18 receiving the user request from the client device 14, various types of available hydrogen solutions are determined from H2 suppliers within delivery range of the user location based at least in part by matching the user request with the hydrogen supplier information (block 204). The displayed hydrogen solutions should only include the H2 suppliers that also match infrastructure and equipment requirements for the specified hydrogen consumption amount and any selected pricing filter option, described below.

The hydrogen supply determination engine 18 calculates total pricing for the available hydrogen solutions (block 206).

The hydrogen supply determination engine 18 displays in a user interface (UI) on the client device 20 a list of hydrogen suppliers that are in delivery range of the user location along with corresponding total pricing (block 208). In certain embodiments, displayed hydrogen suppliers may comprise optimal hydrogen suppliers where optimization of such displayed hydrogen suppliers is based on, singularly or in any combination, one or more of hydrogen cost, delivery cost, distance, hydrogen availability, weekly or monthly hydrogen delivery capacity, whether hydrogen is delivered in liquid or gaseous form, hydrogen generation technology (such as via reformer or electrolysis), or other suitable information that is optimized based on a user's needs input via the UI 300.

FIG. 3B illustrates the UI 300 after receiving results back from the server 12. In this example, the UI 300 displays to the user the available hydrogen solutions for ZIP code 60050 at a consumption rate of 76 Kg per day. The map pane 306 is populated with the user's location (e.g., via a yellow pin) and the locations of the H2 suppliers (e.g. via green pins), and the results pane 308 lists the H2 suppliers, via for example, cards or tiles. Each H2 supplier may be identified by an optional logo, business name and/or contact information. An estimate of the supplier's total H2 pricing per kilogram per month is also displayed along with recurring cost and/or upfront cost.

In a further embodiment, the results may also include other information (not shown), such as a delivery distance, the number of hydrogen deliveries required per month, types of supporting infrastructure to produce and/or store the H2 (e.g., concrete, storage tanks, tubing, etc.), an estimated cost of the supporting infrastructure, and an estimated number of any required permits.

Filter options 310 are displayed to enable the user to filter the results by price, company, and/or by type. The price filter option 312 may be toggled between “low upfront cost” and “low recurring cost”. The company filter option 314 lists unique suppliers and enables the user to check one or more boxes to select which ones will be displayed in the results pane 308. The technology type filter option 316 enables the user to filter the results by technology type, which include liquid, high pressure (HP) gas, electrolysis, and reformer. The selections for the technology type filter option 316 may change depending on the setting for the price filter option 312.

FIG. 3C shows options displayed for the technology type filter option 316 the in UI 300 when the price filter option 312 is toggled to “low recurring.” In this example, the type filter option 316 displays “liquid,” “reformer,” and “electrolysis.”

FIGS. 3D and 3E show alternative embodiments for look and feel of the UI 300′. In addition to ZIP Code and kilograms per day, the UI 300′ enables the user to select hydrogen solutions that include “H2+infrastructure,” “Delivered H2,” and “Infrastructure.”

According to one aspect of the present disclosure, although some of the suppliers may have a plurality of available hydrogen solutions, only the single best hydrogen solution of each H2 supplier is displayed. This way, the user/dealer is not overwhelmed by having to manually sort through, for example, 30 available options from Bethlehem Hydrogen, and 20 available options from OneH2, for instance. Instead, the UI 300 shows each supplier's optimal information, such as best price, based on location, which is what the user/dealer is trying to find.

Referring again to FIG. 2, after the results are displayed the hydrogen supply determination engine 18 enables the user to place an order for hydrogen with one of the displayed suppliers, such that the user receives a physical hydrogen delivery from the selected supplier at the specified user location (block 210).

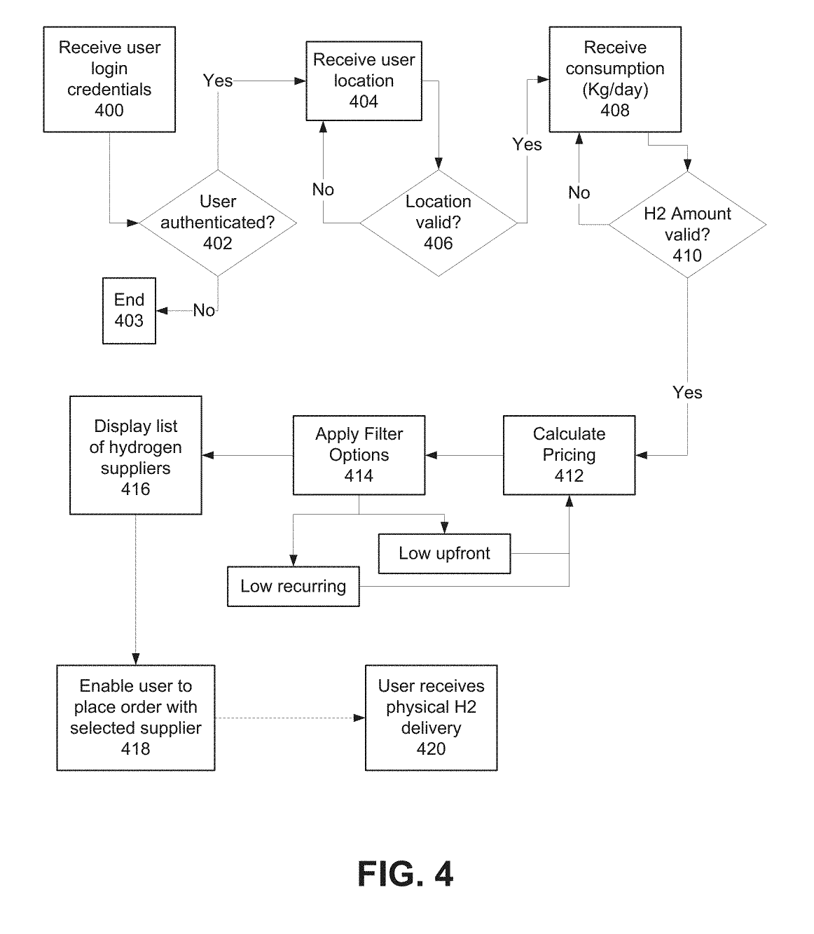

FIG. 4 is a diagram illustrating the process for automatically determining a hydrogen supply solution in further detail. The process begins by one of the servers 12 receiving the user's login credentials (block 400) and determining whether the user is authenticated (block 402). If the user is not authenticated, the process ends (block 403). If the user is authenticated, then the hydrogen supply determination engine 18 receives as input the user location (block 404). In one embodiment, the user location is entered in form of a ZIP Code or address. However, in an alternative embodiment, the users location may be automatically determined using the user's IP address, GPS location of a mobile device, and/or cell tower triangulation.

If it is determined that the user location is invalid (block 406), the process returns to block 404. If the location is valid (e.g. a valid numeric ZIP Code), then the hydrogen supply determination engine 18 receives as input the H2 consumption amount (block 408). If it is determined that the consumption amount is invalid (block 410), the process returns to block 408 for reentry. In one embodiment, the consumption amount is a numeric value ranging from 0 to 5000 in KG per day.

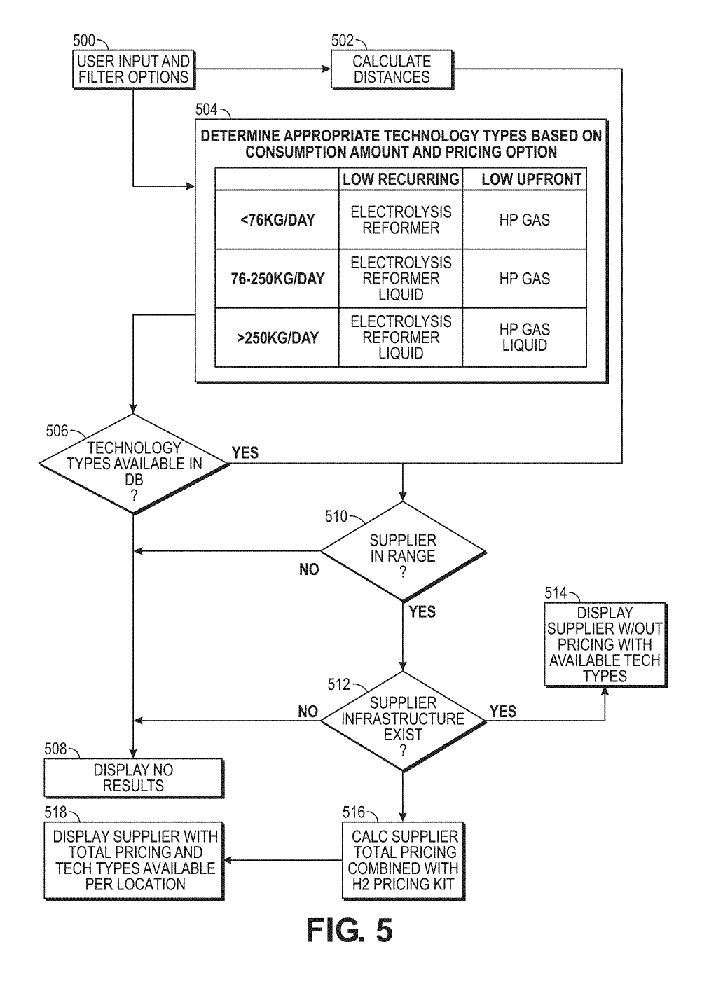

If the consumption amount is valid then the hydrogen supply determination engine 18 calculates H2 pricing (block 412). The calculation of H2 pricing is discussed more fully with respect to FIG. 5. The user selection of filter options is applied to the results (block 414). If the price filter option 312 is toggled between low recurring and low upfront after the price is calculated, then the process returns to block 412 to recalculate the H2 price. After the price is calculated, a list of hydrogen suppliers, and optionally, a list of optimal hydrogen suppliers, along with estimated pricing is displayed in the UI 300 (block 416). Thereafter, the user is enabled to place an order with the selected supplier (block 418), such that the user then receives a physical H2 delivery from that supplier (block 420). In one embodiment, the user may place an order with the selected supplier through the UI 300 by, for example, displaying a contract from the supplier for the user to complete, or by at least linking to the supplier's website.

FIG. 5 is a block diagram illustrating a process of calculating H2 pricing in further detail according to one embodiment. The process may begin by receiving user inputs of user location, hydrogen consumption amount and the pricing filter option of low recurring or low upfront cost (block 500).

Based on the user location, for example, based on a ZIP Code, the hydrogen supply determination engine 18 calculates a distance (e.g., a straight line distance) between the user ZIP Code and the ZIP Codes of the hydrogen suppliers (block 502). In one embodiment, the distance is calculated using longitude and latitude with the haversine formula to create a great-circle distance between the user ZIP Code and all supplier ZIP codes. An example formula is the following:

ROUND((NVL(3963,0)*ACOS((SIN(NVL((SELECT DISTINCT LAT FROM H2_ZIP_CODE WHERE ZIP_CODE=:P3_ZIP),0)/57.29577951)*SIN(NVL(HS.LAT,0)/57.29577951))+(COS(NVL((SELECT DISTINCT LAT FROM H2_ZIP_CODE WHERE ZIP_CODE=:P3_ZIP),0)/57.29577951)*COS(NVL(LAT,0)/57.29577951)*COS(NVL(LON,0)/57.29577951−NVL((SELECT DISTINCT LONGITUDE LON FROM H2_ZIP_CODE WHERE ZIP_CODE=:P3_ZIP), 0)/57.29577951)))),0) DISTANCE_MILES

According to one aspect of the present embodiments, to determine which H2 technology types to search for in the SQL database 24 (block 506), logic is used to first determine the appropriate hydrogen technology types to search for based on the user location and the desired hydrogen consumption amount (block 504). In one embodiment, the logic is based by organizing possible input consumption amounts into categories, and then determining the hydrogen technology type based on the pricing option of low recurring or low upfront cost. An example of the logic is as follows:
If the entered consumption (KG) per day <76 KG, and if the filter option of low recurring is selected, then query for ELECTROLYSIS & REFORMER technology types, else if low upfront is selected, then query for HP GAS;
If KG per day is between 76-250 KG, and if low recurring is selected, then query for ELECTROLYSIS, REFORMER & LIQUID, else if low upfront, then query for HP GAS;
If KG per day >250 KG, and if low recurring is selected, inquiry for ELECTROLYSIS, REFORMER & LIQUID, else if low upfront is selected, then query for HP GAS & LIQUID.

The hydrogen supply determination engine 18 then searches the equipment table 32 and/or the infrastructure table 30 for hydrogen suppliers having the determined hydrogen technology types (block 506). If it is determined that no technology types are available (block 506) then a message may be displayed indicating there are no available suppliers (block 508).

The equipment type must match the H2 technology type returned with the supplier identification. When only Gas HP (high pressure) is returned by the supplier identification, only Gas HP equipment should show under equipment identification and the specific fixed and recurring cost of that piece of equipment should be used in the total cost per KG calculation. When only Liquid is returned by the supplier identification, only Liquid equipment should show under equipment identification and the specific fixed and recurring cost of that piece of equipment should be used in the total cost per KG calculation. When multiple technology types are returned by the supplier identification, the matching equipment types may be returned in equipment identification. In addition, the equipment output must be equal or greater than the H2 input. In certain embodiments, results are returned only where the H2 supplier and the H2 equipment have the same org ID.

If technology types are available, then it is determined whether a corresponding supplier is in range of the user location based on the calculated distances (block 510). For the returned list of suppliers, the suppliers in range of the user location are determined by filtering out the suppliers whose max delivery range is less than the straight line distance calculated in block 502 between the supplier and the user ZIP Code. If there are no suppliers in range, then the process proceeds to block 508. If there are suppliers in range, then a list of in-range suppliers may be created. The hydrogen supply determination engine 18 then retrieves relevant pricing information from the in-range suppliers for use during total price calculations. In one embodiment, the pricing information retrieved comprises delivery cost of hydrogen per mile and the cost of hydrogen per KG.

Next, it is determined if relevant supplier infrastructure exists (block 512). This may be accomplished by using a supplier identifier of the in-range suppliers from the H2 supplier table 28 and searching for matching identifiers in the equipment table 32. If none are found, then the process proceeds to block 508. Otherwise, any hydrogen technology not matching the hydrogen technology determined in block 504 are filtered out. Also filtered out are any remaining equipment having a daily KG capacity less than the user KG per day consumption requirement. The useful life of the equipment in years and the upfront equipment cost are retrieved from the equipment table 32 for use during the total price calculations. If suppliers are found without pricing information, then they are displayed in the UI 300 with available technology types (block 514).

Next, the hydrogen supply determination engine 18 calculates the supplier total pricing combined with any pricing kit (block 516). In one embodiment, the total pricing in cost per KG may be calculated as follows:

Gas ((Distance*cost per mile gas*2*24*useful life of equipment)+(cost per KG of H2*H2 Input*320 days*useful life of equipment)+(Equipment package cost+(monthly cost*12*useful life of equipment)))/(320 days*useful life of equipment*H2 Input)

Liquid ((Distance*cost per mile liquid*2*12*useful life of equipment)+(cost per KG of H2*H2 Input*320 days*useful life of equipment)+(Equipment package cost+(monthly cost*12*useful life of equipment)))/(320 days*useful life of equipment*H2 Input),

where
2*24=Gas is delivered twice a month and the distance is two ways, 2=2 trips, 24=twice a month, and
2*12=Liquid is delivered once a month and 2 ways, 2=2 trips, 12=monthly.
Recurring Cost per KG for Liquid and Gas are may be calculated as follows:

Liquid=(Distance*Per mile delivery cost)+(Price per kg*quantity of kg)+recurring costs KG, and

Gas=((Distance*Per mile delivery cost)+(Price per kg*quantity of kg)*2)+recurring costs KG,

where *2 is for gas deliveries twice per month.

The total pricing results are then displayed to the UI 300 along with the supplier information and technology types available per location (block 518). When equipment is electrolysis or reformer, then upfront and recurring cost should be displayed in the tile. Delivered and Onsite icons may be displayed based on the equipment type returned:

Onsite=Electrolysis and reformer

Delivered=Liquid and HP Gas

When a price is given, an icon may be displayed based on the hydrogen type used for the price calculation. If both onsite and delivered are returned based on parameters, then two separate supplier tiles may be displayed.

When no price is given, icons should be combined on the same tile if both onsite and delivery are an option for the supplier based on input. If both onsite and delivery are returned based on parameters, but supplier has no pricing, then one supplier tile may be displayed with both delivery and onsite icons.

A method and system for process for automatically determining hydrogen supply source has been disclosed. The embodiments shown in the Figures have been described to enable one of ordinary skill in the art to make and use the invention and are provided in the context of a patent application and its requirements without limiting the scope of the invention. One skilled in the art will recognize variations to the embodiments, and that any such variations are within the spirit and scope of the present disclosure. For example, the exemplary embodiment can be implemented using hardware, software, a computer readable medium containing program instructions, or a combination thereof. Software written according to the present disclosure is to be either stored in some form of computer-readable medium such as a memory, a hard disk, or an optical disk and is to be executed by a processor. Accordingly, many modifications may be made by one of ordinary skill in the art without departing from the spirit and scope of the appended claims.

We claim:

1. A computer-implemented method for automatically determining a hydrogen supply source, comprising:
executing on one or more processors, an online tool that enables users to find potential hydrogen options and a rough order magnitude (ROM) pricing; and
based on user specified user location and desired hydrogen consumption amount, filtering through a data repository of supplier solutions and pricing to find a supplier solution for the user, wherein the online tool also determines which technologies, including onsite reformer or electrolysis, or delivery as gas or liquid, should be employed by the user, and an estimated cost for supporting infrastructure and equipment; and
displaying returned results to the user.

2. The computer-implemented method of claim 1, further comprising: storing in a data repository, hydrogen supplier information for a plurality of hydrogen suppliers.

3. The computer-implemented method of claim 2, further comprising: storing for each of the hydrogen suppliers contact data, delivery fees, infrastructure requirements, equipment and technology types, hydrogen output per day, and hydrogen pricing.

4. The computer-implemented method of claim 3, further comprising: receiving by the online tool a request from a client device of the user, wherein the request specifies the user location and the desired hydrogen consumption amount.

5. The computer-implemented method of claim 4, further comprising: displaying a user interface of the online tool on the client device of the user, wherein the user interface includes a main window having a location entry box, a hydrogen consumption amount entry box, a search button, and a results pane.

6. The computer-implemented method of claim 5, further comprising: displaying in the user interface a map pane showing a map of a location of the user and locations of any suppliers displayed in the results pane, and a filter options pane with options for filtering the results.

7. The computer-implemented method of claim 4, further comprising: responsive to the online tool receiving the user request from the client device, determining available hydrogen solutions from hydrogen suppliers within delivery range of the user location.

8. A computer-implemented method for automatically determining a hydrogen supply source, comprising:
storing in a data repository, hydrogen supplier information for a plurality of hydrogen suppliers;
executing, on a server, a hydrogen supply engine that receives a user request from a client device for a hydrogen supply source and cost information by specifying a user location and a desired hydrogen consumption amount;
responsive to receiving the user request from the client device by the hydrogen supply engine, determining types of available hydrogen solutions from suppliers within delivery range of the user location based at least in part by matching the user request with the hydrogen supplier information;
calculating total pricing for the available hydrogen solutions;
displaying, in a user interface of the client device, a list of hydrogen suppliers that are in delivery range of the user location along with a corresponding total pricing; and
enabling the user to place an order for hydrogen with one of the displayed hydrogen suppliers, such that the user receives a physical hydrogen delivery from the supplier at the specified user location.

9. The computer-implemented method of claim 8, wherein storing in a data repository, hydrogen supplier information for a plurality of hydrogen suppliers, further comprises:
storing information for each of the plurality of hydrogen suppliers location information, contact information, maximum amount of hydrogen stored and dispensed, dispensary locations, maximum delivery range for each location, hydrogen costs per kilogram, and cost per delivery mile.

10. The computer-implemented method of claim 9, further comprising: storing in the data repository for each of the plurality of hydrogen suppliers:
infrastructure information requirements; and
equipment information of offered equipment packages, including a liquid infrastructure or a delivered infrastructure, and electrolysis or reformer.

11. The computer-implemented method of claim 10, further comprising:
storing the information for each of the plurality of hydrogen suppliers in database tables, and indexing the database tables by a hydrogen supplier identifier (ID).

12. The computer-implemented method of claim 8, wherein calculating total pricing for the available hydrogen solutions further comprises:
receiving user inputs of the user location, the desired hydrogen consumption amount and a pricing filter option of low recurring or low upfront cost.

13. The computer-implemented method of claim 12, wherein calculating total pricing for the available hydrogen solutions further comprises:
determining appropriate hydrogen technology types to search for in the data repository based on the user location and the desired hydrogen consumption amount.

14. The computer-implemented method of claim 13, wherein determining the appropriate hydrogen technology types to search for based on the user location and the desired hydrogen consumption amount further comprises:
organizing hydrogen consumption amounts into categories, and determining the hydrogen technology types based on the pricing option of low recurring or low upfront, wherein the hydrogen technology types include Electrolysis, Reformer and Liquid, and High Pressure Gas and Liquid.

15. The computer-implemented method of claim 14, wherein calculating total pricing for the available hydrogen solutions further comprises:
searching the repository for hydrogen suppliers having the determined hydrogen technology types.

16. The computer-implemented method of claim 15, wherein calculating total pricing for the available hydrogen solutions further comprises:
responsive to retrieving the appropriate hydrogen technology types, determining whether a corresponding hydrogen supplier is in range of the user location by filtering out the hydrogen suppliers whose maximum delivery range is less than a straight line distance between the supplier location and the user location.

17. The computer-implemented method of claim 16, wherein calculating total pricing for the available hydrogen solutions further comprises:
responsive to retrieving hydrogen suppliers in range, creating a list of in-range hydrogen suppliers, and retrieving pricing information from the in-range hydrogen suppliers, wherein the pricing information retrieved comprises a delivery cost of hydrogen per mile and a cost of hydrogen per KG.

18. The computer-implemented method of claim 17, wherein calculating total pricing for the available hydrogen solutions further comprises:
determining if supplier infrastructure exists for the hydrogen suppliers in range; and
retrieving a useful life of the equipment in years and an equipment package cost for use during the total price calculations.

19. The computer-implemented method of claim 17, wherein calculating total pricing for the available hydrogen solutions further comprises:
calculating the total pricing and cost per kilogram (KG) by:
Gas=((Distance*cost per mile gas*2*24*useful life of equipment)+(cost per KG of H2*H2 Input*320 days*useful life of equipment)+(Equipment package cost+(monthly cost*12*useful life of equipment)))/(320 days*useful life of equipment*H2 Input)
Liquid=((Distance*cost per mile liquid*2*12*useful life of equipment)+(cost per KG of H2*H2 Input*320 days*useful life of equipment)+(Equipment package cost+(monthly cost*12*useful life of equipment)))/(320 days*useful life of equipment*H2 Input),
where 2*24=Gas is delivered twice a month and the distance is two ways, 2=2 trips, 24=twice a month, and 2*12=Liquid is delivered once a month and 2 ways, 2=2 trips, 12=monthly; and
calculating recurring cost per KG for liquid and gas by:
Liquid=(Distance*Per mile delivery cost)+(Price per kg*quantity of kg)+recurring costs KG, and
Gas=((Distance*Per mile delivery cost)+(Price per kg*quantity of kg)*2)+recurring costs KG,
where *2 is for gas deliveries twice per month.

20. The computer-implemented method of claim 8, wherein displaying, in a user interface of the client device, a list of hydrogen suppliers that are in delivery range of the user location further comprises:
displaying in the user interface a map pane that is populated with the user's location and the locations of the hydrogen suppliers, and displaying in the user interface a results pane that listing the hydrogen suppliers.

21. The computer-implemented method of claim 8, wherein displaying, in a user interface of the client device, a list of hydrogen suppliers that are in delivery range of the user location further comprises:
including in the list of hydrogen suppliers only the hydrogen suppliers that also match infrastructure and equipment requirements for the specified desired hydrogen consumption amount and any selected pricing filter option.

22. The computer-implemented method of claim 8, wherein displaying, in a user interface of the client device, a list of hydrogen suppliers that are in delivery range of the user location further comprises:
displaying in the user interface for each of the hydrogen suppliers a delivery distance, a number of hydrogen deliveries required per month, types of supporting infrastructure to produce and/or store the hydrogen, an estimated cost of supporting infrastructure, and an estimated number of any required permits.

23. The computer-implemented method of claim 8, wherein displaying, in a user interface of the client device, a list of hydrogen suppliers that are in delivery range of the user location further comprises:
for the hydrogen suppliers having a plurality of available hydrogen solutions, displaying only a single best hydrogen solution.

24. An executable software product stored on a computer-readable medium containing program instructions for automatically determining a hydrogen supply source, the program instructions for:
executing on one or more processors, an online tool that enables users to find potential hydrogen options and a rough order magnitude (ROM) pricing;
based at least on user specified user location and desired hydrogen consumption amount, filtering through a data repository of supplier solutions and pricing to find a supplier solution for the user, wherein the online tool also determines which technologies, including onsite reformer or electrolysis, or delivery as gas or liquid, should be employed by the user, and an estimated cost for supporting infrastructure and equipment; and
displaying returned results to the user.

25. A system, comprising:
a memory;
a processor coupled to the memory; and
a software component executed by the processor that is configured to:
store in a data repository, hydrogen supplier information for a plurality of hydrogen suppliers;
execute, on a server, a hydrogen supply engine that receives a user request from a client device for a hydrogen supply source and cost information by specifying a user location and a desired hydrogen consumption amount;
responsive to receiving the user request from the client device by the hydrogen supply engine, determine types of available hydrogen solutions from suppliers within delivery range of the user location based at least in part by matching the user request with the hydrogen supplier information;
calculate total pricing for the available hydrogen solutions;
display, in a user interface of the client device, a list of hydrogen suppliers that are in delivery range of the user location along with a corresponding total pricing; and
enable the user to place an order for hydrogen with one of the displayed hydrogen suppliers, such that the user receives a physical hydrogen delivery from the supplier at the specified user location.
